(19) United States
(12) Patent Application Publication
(10) Pub. No.: US 2009/0186204 A1
(43) Pub. Date: Jul. 23, 2009

(54) Multilayer Thermoshrinkable Films

(76) Inventors: Nicolas Kokel, Rhode Saint Genese (FR); Justus Christof, Speyer (DE)

Correspondence Address: LyondellBasell Industries, 3801 WEST CHESTER PIKE, NEWTOWN SQUARE, PA, 19073, US

(21) Appl. No.: 12/223,417

(22) PCT Filed: Jan. 9, 2007
(86) PCT No.: PCT/EP2007/050178

§ 371 Date: Jul. 30, 2008

Related U.S. Application Data
(60) Provisional application No. 60/771,925, filed on Feb. 9, 2006.

(30) Foreign Application Priority Data
Feb. 2, 2006 (EP) 06002144.1

(51) Int. Cl. B32B 27/32; B32B 7/00

(52) U.S. Cl. 428/213; 428/516

(57) ABSTRACT

A multilayer thermoshrinkable film and a process for manufacturing the same are described. The film is particularly suitable for packaging applications, in particular as a packaging thermoshrinkable hood for enclosing an item or a secondary packaging essentially consisting of polyethylene. The multilayer thermoshrinkable film of the invention comprises: a) at least one first film layer comprising a linear ethylene copolymer having a density of 0.920 to 0.950 g/cm; b) at least one second film layer comprising a first copolymer of propylene with ethylene and/or at least one CH₂═CHR₁ α-olefins, where R₁ is a hydrocarbon radical having 2-10 carbon atoms; and c) at least one third film layer comprising a linear ethylene copolymer having a density of 0.920 to 0.950 g/cm; wherein said at least one first film layer is arranged between said at least one second film layer and at least one third film layer. The multilayer thermoshrinkable film, which has improved shrinkage and seal properties, may be advantageously produced by means of standard symmetrical film extrusion plants.

### FIELD OF THE INVENTION

The present invention relates to a multilayer film and, in particular, to a multilayer thermoshrinkable film based on polyethylene. More particularly, the present invention relates to a multilayer thermoshrinkable film comprising at least one first film layer including an ethylene polymer essentially giving the multilayer film the thermoshrinkable property, and at least one second film layer intended to be in contact with the item(s) to be packed and able not to adhere thereto also when the item(s) to be packed are essentially made of an ethylene polymer.

In the present description and in the following claims, unless otherwise indicated, the term “polymer” is used to indicate both a homopolymer, i.e. a polymer comprising repeating monomeric units derived from equal species of monomers, and a copolymer, i.e. a polymer comprising repeating monomeric units derived from at least two different species of monomers, in which case reference will be made to a binary copolymer, terpolymer, etc. depending on the number of different species of monomers used, the copolymer being for example a block polymer, a random, as well as an alternating polymer.

The present invention also relates to a process for manufacturing the above-mentioned film.

The multilayer thermoshrinkable film of the invention is particularly suitable to be used either as primary packaging, i.e. as the only packaging film enclosing an item or a plurality of items, or as secondary packaging for packing an item or a plurality of items already enclosed by a primary packaging.

The present invention also relates to the use of such a multilayer thermoshrinkable film as a packaging film, in particular in the form of a polyethylene based film generally known in the art with term of “non-fusion shrink hood”, i.e. of a hood not sticking to polyethylene based items or packaging. Polyethylene based items or packaging are items and, respectively, packaging, essentially made of polyethylene, i.e. containing polyethylene as essential component.

In the present description and in the following claims, the term “hood” is used to indicate a tube film having a first open end and a second end closed via sealing, which tube film is intended to be sleeved onto an item, for example a palletized load, to be protected or packed, and to be shrunk therearound by transfer of heat.

### PRIOR ART

A thermoshrinkable film is made of a polymer, or of a blend of polymers, which is able—upon exposure to a certain temperature—to shrink or, if restrained from shrinking, to generate shrink tension within the film. Such a film is widely used for protecting different types of items, for example loads and packs of goods which may be individually packaged or packaged in the form of stacked goods.

There are two main categories of thermoshrinkable films depending on the type of process by means of which the films are manufactured, namely blown shrink films and oriented shrink films.

Blown shrink films are usually made by a blow bubble film process, while oriented shrink films are usually made by biaxial and uniaxial orientation processes including double bubble method, bioriented method, where a simultaneous longitudinal and transverse orientation is carried out, tape bubble, trapped bubble or tenter framing method.

The manufacture of thermoshrinkable films, as is well known in the art, may be generally accomplished by extrusion of the polymer which has been heated to, or slightly above, the flow or melting point thereof through an extrusion die in planar or tubular form.

After a post-extrusion quenching to cool, the extrudate is then reheated to the orientation temperature range of the polymer. The orientation temperature range for a given film will vary depending on the polymer and blends of polymers the film may be made of. However, the orientation temperature range may generally be stated to be above room temperature and below the melting point of the film.

Polyethylene based thermoshrinkable films are known. Thermoshrinkable films made of low density polyethylene (LDPE) or linear low density polyethylene (LLDPE) are also known. LLDPE is mainly used in oriented shrink films. LDPE is used in blown shrink films due to its good shrink behavior in terms of equilibrated level of shrink in the machine and in the transverse direction and low process shrink temperature. It is also known to blend LLDPE with LDPE as a minor blending component in order to improve the drawability in the film blowing process, to improve the sealing behavior and to minimize the tendency to holes formation during the thermal shrink process.

Polyethylene based multilayer thermoshrinkable films, in particular comprising a first film layer including LLDPE, and a second and third film layers comprising polymer mixtures suitable for conferring sealing or optical properties to the film and for preventing the film sticking together during working, are also known in the art. The first film layer, conferring the shrinkability to the film, is generally an inner layer, while the second and the third layer are generally outer layers, of which one is intended to be in contact with the item(s) to be packaged, while the other outer layer is intended to be exposed to the environment.

When the item to be packaged is itself essentially made of polyethylene, such as for example in the case of polyethylene based containers, or when the item to be packaged is in turn already packaged into a primary polyethylene based packaging film, a polyethylene based thermoshrinkable film, which is used as primary or, respectively, as secondary packaging film, may inconveniently adhere or even seal onto the polyethylene item or onto the primary polyethylene packaging film during the heating step of the packaging process.

In order to avoid the adhesion problem of the film to the item to be wrapped, polyethylene based multilayer films have also been developed which, in addition to a layer of polyethylene, are provided with outer layers either provided with antiblocking additives or made of polypropylene or ethylene/propylene copolymers (EPC).

Examples of prior art polyethylene based multilayer films are described in European patent applications EP-A-0 586 160 and EP-A-0 595 252.

EP-A-0 586 160 describes a thermoshrinkable multilayer film comprising a core layer made of LLDPE and outer layers which may be made of blends of EPC with polybutene (PB), or else blends of polypropylene (PP) or ethylene/propylene copolymers (EPC) with a propylene/butene copolymer (PBC), or of PBC. The main purpose of using PBC in the outer layers is said to be that of attaining good lap seal characteristics.

EP-A-0 595 252 discloses three-layer thermoshrinkable films comprising a shrink layer made of LLDPE to which additives such as hydrogenated hydrocarbon resins, polyethylene or polypropylene waxes, VLDPE, etc., are added, and outer layers made of polypropylene or EPC, to which the same additives are added.

Further examples of thermoshrinkable multilayer films are given in patent U.S. Pat. No. 4,532,189. This patent describes three or five layer films including a core layer comprising LLDPE or linear medium density polyethylene (LMDPE) and optionally further comprising EPC, ethylene/vinyl-acetate copolymers (EVA) or low-density polyethylene (LDPE), and outer layers comprising EPC and optionally further comprising homopolymeric propylene (PP), LLDPE or LMDPE. Intermediate layers are also envisaged between the core layer and the outer layers, and such intermediate layers are made of EVA or mixtures of LLDPE or LMDPE with ionomeric resins.

Such prior art films have however a number of disadvantages which are essentially related to the nature of the composition of the different layers. A first disadvantage may be found in that when the two outer layers are made up of EPC and/or PP, the film can only be heat-sealed at relatively high temperature because outer layers of this composition do not allow to achieve a sufficient sealing at low temperature. A second disadvantage lies in that an insufficient shrink effect is achieved. A third disadvantage may be found in that the association of polyethylene-based core layer with two polypropylehe-based outer layers, i.e. between materials which are poorly compatible per se, can cause an undesired delamination of the film layers of the film so produced.

An example of multilayer thermoshrinkable films comprising outer layers made of EPC is given in international application WO 97/22475, which discloses a multilayer thermoshrinkable film comprising at least one layer including a polyolefin composition comprising a copolymer of propylene having a predetermined crystallinity and at least one layer including a linear copolymer of ethylene having a density between 0.88 and 0.945 g/cm³. More particularly, WO 97/22475 discloses a three-layer film having a thickness of 0.19 μm and comprising a core shrink layer made of a polymer composition comprising 85% of an ethylene/1-butene copolymer and 15% of a terpolymer of propylene with ethylene and 1-butene, and outer layers made of a polyolefin composition comprising a propylene/1-butene/ethylene terpolymer.

If not otherwise indicated, in the present description and in the following claims all percentages are percentages by weight.

On the one side, the film disclosed by WO 97/22475 is unsuitable to manufacture shrink hoods because the film therein disclosed is prepared by the double bubble method, i.e. by a method which has been mainly designed to manufacture only very thin films having a thickness which does not comply with the requirements set in shrink hoods applications.

Furthermore, the double bubble method must be carried out in production lines comprising a main blow film line and additional heating and cooling devices which render the global production line economically inconvenient due to both investment and service costs.

On the other side, the film disclosed by WO 97/22475 has an insufficient shrinkability, contains a propylene copolymer on both outer layers, which is economically inconvenient, and exhibits an inadequate bubble stability during the film blowing step.

As is known, blown thermoshrinkable films prepared by a blow bubble film process are suitable to manufacture shrink hoods. For such application, once the hood has been sleeved onto the item(s) to be packed, thermal stress is applied by introducing the sleeved item(s) into a heating oven or by translating a gas or electrically heated frame alongside the film hood. As a result of the heat transferred to the film, the shrink process takes place, the frozen mechanical stress relaxes and, as a consequence, the film dimension reduces. In this way, the item(s) is/are tightly maintained or protected from external influences such as rain water, dust contamination, finger marks, etc. The shrink process in the manufacture of hoods is described for example in U.S. Pat. No. 3,673,703, U.S. Pat. No. 3,727,324, U.S. Pat. No. 3,744,146, U.S. Pat. No. 5,471,818, EP 0252527, EP 0375850, EP 0649 791, GB 2014534.

Standard thermoshrinkable blow films are more commonly based on LDPE as a main component due to its good shrink behavior, but LDPE hoods may adhere to the item to be wrapped when the latter is also base on polyethylene.

In order to avoid the adhesion problem of the hood to the item to be wrapped, U.S. Pat. No. 3,933,244 teaches to use a thermoshrinkable LDPE film hood modified with an antiblocking additive with the aim of reducing the contact area between the hood and the item wrapped in a primary polyethylene film. In this way, however, adhesion can only be reduced to some extent but cannot be eliminated.

Alternatively, the film may be a multilayer film comprising a non-adhesive outer layer intended to be in contact with the polyethylene item, so as to avoid any contact between the polyethylene shrink layer and the polyethylene item. The non-adhesivity is generally obtained by an outer layer having no or poor affinity to polyethylene under shrink temperatures due to a physical incompatibility between the outer layer resin and polyethylene. However, since the outer layer has a poor or no adhesion to the polyethylene shrink layer, this can lead to stress induced delamination of the seal. It is therefore necessary to provide a compatibilizing layer between the non-adhesive outer layer and the polyethylene shrink layer, which compatibilizing layer is generally called tie layer. In this case, the polyethylene shrink layer is an outer film layer separated by at least two additional film layers from the item to be packaged, these two additional layers being at least an outer non-adhesive layer and an intermediate tie layer. In order to minimize the production costs of the film, the thickness of both the intermediate tie layer and of the non-adhesive outer layer are set as low as possible. Therefore, the outer polyethylene shrink layer has generally a prevailing thickness with respect to the thickness of both the intermediate tie layer and of the non-adhesive outer layer, thus giving rise to a film which is asymmetrical. A non-symmetrical configuration of the film of such kind necessarily requires an asymmetrical blow film extrusion line which must be specifically designed for the purpose. Such specifically designed blow film extrusion line consists of a first extruder intended to extrude a polyethylene shrink layer having a prevailing thickness, and of additional second and third extruders intended to extrude the intermediate tie layer and, respectively, the non-adhesive outer layer, each one of smaller thickness with respect to the thickness of the polyethylene shrink layer.

An example of multilayer thermoshrinkable films for the production of non sticking hoods prepared by the blow film extrusion process is given in European application EP-A1-1 332 868. More in particular, EP-A-1 332 868 discloses a film comprising a polyethylene shrink layer having a prevailing thickness, an intermediate tie layer comprising LLDPE and a propylene copolymer or a vinylacetate copolymer, and a non-adhesive outer layer comprising one or more propylene copolymers.

### SUMMARY OF THE INVENTION

In view of the above, the Applicant has perceived the need of providing a multilayer thermoshrinkable film, in particular suitable for the preparation of non-fusion shrink hoods, which has an improved shrinkability and sealability, an improved adhesion between adjacent layers but no adhesion onto a possible underlying primary packaging film or onto an underlying item essentially made of polyethylene while, at the same time, being capable of being produced in a flexible and easy manner by means of standard film extrusion plants.

In other words, the technical problem underlying the present invention is that of providing a multilayer thermoshrinkable film, as well as a non-fusion shrink hood prepared therefrom, which is both easily processable on any conventional film extrusion equipment, such as for example standard symmetrical blow film lines, heat shrinkable at a low shrinkage temperature, typically ranging from 110° C. to 180° C., heat sealable at a low sealing temperature, and which, once shrank onto the item to be packaged, does not adhere thereto.

The Applicant has found that a way to improve the shrinkability and the sealing strength of a multilayer thermoshrinkable film comprising at least one first, one second and one third film layer, while avoiding undesired delamination between the layers, is that of envisaging that at least two adjacent film layers out of the at least three film layers, namely the outer layer intended to be in contact with the environment and the inner layer arranged between the latter and the outer layer intended to be in contact with the item(s) to be packed, have at least one linear polyethylene in common having a density in the range from 0.920 to 0.950 g/cm³, i.e. substantially in the range of linear low density polyethylene (LLMDPE) and of linear medium density polyethylene (LMDPE).

To ensure a proper sealing action of the film while avoiding any adhesion phenomenon between the thermoshrinkable film and the item to be packaged, according to the present invention it is also envisaged that the film layer intended to be in contact with the item(s) to be packaged comprises a specific copolymer of propylene.

The present invention therefore relates to multilayer thermoshrinkable films in which at least two adjacent layers—the above-mentioned first layer and third layer—comprise a linear ethylene copolymer, in particular a linear copolymer of ethylene with α-olefins having 3-12 carbon atoms, while at least one layer—the above-mentioned second layer—comprises a particular copolymer of propylene.

In other words, the above-mentioned technical problem is solved by a multilayer thermoshrinkable film comprising:

a) at least one first film layer comprising a linear ethylene copolymer having a density of 0.920 to 0.950 g/cm³;

b) at least one second film layer comprising a first copolymer of propylene with ethylene and/or one or more CH₂═CHR₁ α-olefins, where R₁ is a hydrocarbon radical having 2-10 carbon atoms;

c) at least one third film layer comprising a linear ethylene copolymer having a density of 0.920 to 0.950 g/cm³;

wherein said at least one first film layer is arranged between said at least one second film layer and at least one third film layer.

For the purpose of the present description and of the claims which follow, except where otherwise indicated, all numbers expressing amounts, quantities, percentages, and so forth, are to be understood as being modified in all instances by the term “about”. Also, all ranges include any combination of the maximum and minimum points disclosed and include any intermediate ranges therein, which may or may not be specifically enumerated herein.

More particularly, once the film is used, preferably as packaging film suitable for protecting an item (or a collection of items) from the environment, and more preferably as a non-fusion shrink hood, the first film layer is intended to constitute the inner shrink layer thereof, i.e. the layer substantially conferring the thermoshrinkable property to the multilayer film, while the second layer is intended to constitute the layer sealing the item to be packaged, i.e. the layer intended to be substantially in contact with such item(s), and the third film layer is intended to constitute the interface with the external environment from which the item(s) is(are) to be protected.

Thanks to the fact that the third film layer comprises the same linear ethylene polymer present in the first film layer, and in particular thanks to the fact that this polymer is a linear ethylene copolymer having a density of 0.920 to 0.950 g/cm³, it is advantageously possible to attain an improved shrinkability with respect to the prior art multilayer films containing a single film layer comprising linear ethylene copolymer. In other words, the provision of the two above-mentioned adjacent first film layer and second film layer, comprising LLDPE and/or LMDPE as better defined in the following, is deemed to attain the above-mentioned improvement in the shrinkability of the film.

More in detail, the film of the invention is able, upon exposure to a certain temperature, and particularly to a relatively low temperature comprised between 110° C. and 180° C., to shrink.

The film of the invention is also able, upon exposure to a certain temperature, and particularly to a relatively low temperature, to perform a sealing action.

Furthermore, the provision that the first film layer and that the third film layer comprise both a linear ethylene copolymer having a density of 0.920 to 0.950 g/cm³ advantageously allows an improved bubble stability to be achieved during the film blowing process.

A further advantage lies in that, thanks to the above-mentioned structure of the film, and in particular thanks to the fact that the first film layer, i.e. the layer substantially conferring the thermoshrinkable property to the multilayer film, is arranged between the at least one second film and the at least one third film, i.e. is an intermediate layer sandwiched between two outer film layers in a central position of the film, even when the first layer has a prevailing thickness with respect to both the second and third layers, the film may still have a substantially symmetrical configuration, as better described in the following with reference to a preferred embodiment of the film of the invention. As a consequence, the film of the present invention may be advantageously produced according to the blow film extrusion process in standard symmetrical blow lines having a symmetrical configuration, thus avoiding that a specifically designed extrusion equipment is to be provided.

In the present description and in the following claims, a standard “symmetrical blow line” is intended to be a blow line adapted to manufacture conventional multilayer symmetrical blown films. This line comprises at least three extruders arranged in a parallel manner to each other, of which an intermediate extruder is intended to form an intermediate layer preferably having a prevailing thickness, while additional extruders arranged laterally with respect to the first central extruder and having the same size are intended to form a respective second and third film layer.

In such a manner, it is advantageously possible to produce the film of the invention by means of a conventional extrusion blow plant having a symmetrical configuration.

Thanks to the fact that the second film layer, i.e. the film layer intended to constitute the layer sealing the item(s) to be packaged and thus to be in contact with such item(s), comprises a copolymer of propylene, which does not stick to polyethylene, the second film layer advantageously does not stick to the item(s) also when this(these) is(are) essentially made of polyethylene or is(are) in turn already wrapped into a polyethylene film. In this way, the multilayer thermoshrinkable film of the invention may be conveniently used for the packaging of items consisting of a polyethylene based material, or of items wrapped in a primary packaging consisting of a polyethylene based material.

Furthermore, the multilayer thermoshrinkable film of the invention contains a propylene copolymer in one outer layer, namely the second film layer, which makes the film of the invention economically convenient with respect to the prior art films having two outer layers containing propylene copolymers.

The copolymer of propylene of the second film layer has an adequate adhesion to the ethylene copolymer of first film layer, so that no delamination phenomenon is observed between these film layers. It is therefore no necessary to provide a tie layer as defined above with reference to the discussion of the prior art.

The copolymer of the at least one first film layer and of the at least one third film layer is a linear ethylene copolymer having a density ranging from 0.920 to 0.950 g/cm³, thus including linear low density polyethylene (LMDPE), linear medium density polyethylene (LMDPE) and also linear copolymers having a density above 0.940 g/cm³, which are normally referred to as high density polyethylene (LHDPE).

In the present description and in the following claims, the terms LLDPE, LMDPE and LHDPE are used to indicate a class of polymers essentially comprising linear copolymers of ethylene with α-olefins having 3-12 carbon atoms.

Contrary to the molecules of conventional low, medium or high density polyethylenes prepared according to a free radical polymerization process carried out at high pressure, in the order of 1500 to 3000 bar, which are highly branched, the molecules of the copolymers LLDPE, LMDPE and LHDPE are obtained according to a catalytic polymerization process at low pressure, i.e. lower than 50 bar, and are referred to as “linear” in that they comprise long polyethylene chains with relatively few comonomer side chain branches or cross-linked structures. Preferably, the linear copolymer of ethylene as defined above essentially comprises one or more CH₂═CHR α-olefins where R is a hydrocarbon radical having 1-10 carbon atoms, such as for example propylene, 1-butene, 1-pentene, 1-hexene, 4-methyl-1-pentene and 1-octene, preferably 1-butene, 1-hexene, and 1-octene, more preferably 1-butene.

Preferably, the linear copolymer of ethylene as defined above contains up to 20 mol % of one or more CH₂═CHR α-olefins, preferably selected from the group described above, more preferably from 2 to 20 mol % thereof, depending on the broadness of the molecular weight distribution (and thus depending essentially on the catalyst used to prepare the copolymer) and on the density of the copolymer.

Preferably, the above-mentioned linear ethylene copolymer has a density of 0.920 to 0.940 g/cm³.

Within such preferred range of density, the film of the invention is advantageously provided with adequate stiffness.

More preferably, the linear ethylene copolymer has a density of 0.927 to 0.943 g/cm³ and, still more preferably, the linear ethylene copolymer has a density of 0.930 to 0.940 g/cm³.

Advantageously, a film in which the linear ethylene copolymer has a density within such preferred ranges has improved mechanical properties, in particular in terms of creep resistance, tear propagation resistance, puncture resistance and impact resistance and, specifically, in terms of an improved balance thereof. Furthermore, within such preferred values of density a further improvement in stiffness is advantageously achieved, which conveniently allows to reduce the thickness of the film.

According to a preferred embodiment of the invention, the linear ethylene copolymer of the first film layer and of the third film layer has a MFR (190/2.16) lower than 5.0 g /10 min, more preferably lower than 3.0 g /10 min and, still more preferably, lower than 1.0 g /10 min.

In the present description and in the following claims, the term “MFR” indicates the “melt flow rate”. The melt flow rate MFR(190/2.16) is determined at 190° C. under a load of 2.16 kg in accordance with ISO 1133.

Thanks to the above-mentioned preferred values of melt flow rate, the rheological behavior of the linear ethylene copolymer is particularly advantageous in terms of flowability, with ensuing convenient extrudability, while maintaining processability and in particular bubble stability such as to allow the film of the invention to be produced by means of the blow film process. Furthermore, in the above-mentioned preferred ranges of MFR, it is advantageously possible to obtain a thermoshrinkable multilayer film having balanced shrink properties both in the machine and in the transverse direction, thus further improving the shrinkage properties of the thermoshrinkable multilayer film of the invention.

More preferably, the linear ethylene copolymer has a MFR (190/2.16) lower than 0.8 g /10 min, still more preferably lower than 0.5 g /10 min, more in particular lower than 0.3 g /10 min, and still more in particular lower than 0.25 g /10 min.

A particularly preferred range of MFR(190/2.16) is from 0.05 to 1.0 g/10 min, more preferably from 0.05 to 0.8 g /10 min, still more preferably from 0.05 to 0.3 g/10 min and, still more preferably, from 0.1 to 0.25 g/10 min. Preferably, the linear ethylene copolymer of the first film layer and of the third film layer has a MFR (190/21.6) lower than 21.0 g/10 min, more preferably lower than 14.0 g/10 min and, still more preferably, from 10.0 g/10 min 14.0 g/10 min, in particular from 11.0 g/10 min 14.0 g/10 min.

In this case, the melt flow rate MFR (190/21.6) is determined at 190° C. under a load of 21.6 kg in accordance with ISO 1133.

According to a preferred embodiment of the multilayer thermoshrinkable film of the invention, the first film layer contains substantially no ethylene acetate copolymer, and has in particular a content of ethylene acetate copolymer lower than 1 wt % based on the total weight of the first film layer.

Preferably, the first film layer, in addition to the linear ethylene copolymer having a density of 0.920 to 0.950 g/cm³ and, more preferably, having a density within the most preferred ranges defined above, further comprises a propylene copolymer as that provided in the second film layer, i.e. a copolymer of propylene with ethylene and/or one or more CH₂═CHR₁ α-olefins, where R₁ is a hydrocarbon radical having 2-10 carbon atoms.

In this way, an improved adhesion between the first film layer and the second film layer is advantageously achieved.

Such propylene copolymer optionally provided in the first film layer is preferably provided in an amount lower than 10 wt %, more preferably comprised between 0.5 and 5 wt % and, still more preferably, comprised between 0.5 and 3 wt %, based on the total weight of the first film layer.

The propylene copolymer optionally provided in the first film layer may have the preferred features described in the following with reference to the second film layer in the sense that, although the preferred embodiments described below are mainly defined through further specified features of the second film layer, the considerations made with reference to the propylene copolymers are valid both with regard to the propylene copolymers provided in the second film layer and to the propylene copolymers optionally provided in the first film layer.

Preferably, the second film layer comprises a first propylene copolymer containing more than 70% by weight of propylene.

In this way, any possible adhesion between the multilayer film of the invention and the item to be packaged, particularly when the latter is essentially made of polyethylene or is already covered by a primary polyethylene base packaging film, is advantageously completely eliminated.

Preferably, the second film layer comprises a first propylene copolymer which is a random copolymer of propylene and one ore more C₄-C₁₀ α-olefins or a blend of random copolymers of propylene and one or more C₄-C₁₀ α-olefins having different composition, said copolymer or blend of copolymers containing 4-14% by weight of a-olefins units.

According to an alternative embodiment of the invention, the second film layer comprises a first propylene copolymer having a xylene-insoluble fraction greater than 80, preferably greater than 85%, a maximum melting peak at temperatures above 120° C. and a crystallinity content such that at 90° C. the percentage of material melted is greater than 10%.

In order to determine the xylene soluble fraction, 2.5 g of polymer and 250 cm³ of xylene are introduced in a glass flask equipped with a refrigerator and a magnetical stirrer. The temperature is raised in 30 minutes up to the boiling point of the solvent. The clear solution obtained in this manner is then kept under reflux and stirring for further 30 minutes. The closed flask is then kept for 30 minutes in a bath of ice and water and in thermostatic water bath at 25° C. for 30 minutes as well. The solid so formed is filtered on quick filtering paper. 100 cm³ of the filtered liquid is poured in a previously weighted aluminum container which is heated on a heating plate under nitrogen flow so as to remove the solvent by evaporation. The container is then kept in an oven at 80° C. under vacuum until constant weight is obtained.

The maximum melting peak and the crystallinity content at a given temperature are determined by differential scanning calorimetry (DSC) by using the method described later.

Preferably, the first propylene copolymer has a crystallinity such that at 90° C. the percentage of material melted is greater than 15%; more preferably, the crystallinity is such that at 100° C. the percentage of material melted is greater than 20% and at 110° C. the percentage of material melted is greater than 30%.

Preferably, the first propylene copolymer generally contains more than 70% by weight of units derived from propylene, in particular 80-94% by weight of units derived from propylene, 1-5% by weight of units derived from ethylene and 5-15% by weight of units derived from the CH₂═CHR₁ α-olefin.

According to a preferred embodiment of the invention, the first copolymer of propylene provided in the at least one second film layer has a MFR(230/2.16) lower than 10 g/10 min, more preferably comprised in the range 0.2-8.5 g/10 min and, still more preferably, from 0.5 to 1.0 g/10 min. For the purposes of this invention, the term “MFR(230/2.16)” refers to the “melt flow rate” of a polypropylene as determined at 230° C. under a load of 2.16 kg in accordance with ISO 1133. Preferably, the second film layer further comprises a second copolymer of propylene with ethylene and/or at least one CH₂═CHR₁ α-olefin, where R₁ is a hydrocarbon radical having 2-10 carbon atoms. When the comonomer is ethylene, the copolymer preferably contains 1-5% by weight of units derived from ethylene. In this case, the above-mentioned second film layer preferably comprises 40-80 parts by weight of said first copolymer of propylene with ethylene and 20-60 parts by weight of said second copolymer of propylene with ethylene.

According to a preferred embodiment of the invention, the second copolymer of propylene provided in the at least one second film layer has a MFR(230/2.16) lower than 10 g/10 min, more preferably comprised in the range 4-8 g/10 min and, still more preferably, comprised in the range 4-6 g/10 min.

Compositions comprising the above-mentioned first and second propylene copolymers may be produced by mixing both components in the molten state, for example in a mixer having a high homogenizing power or, alternatively, directly in an extruder. Compositions comprising these first and second propylene copolymers are preferably produced directly by synthesis by using a sequential polymerization process comprising at least two stages, where, in any order, propylene and ethylene and/or at least one and/or at least one CH₂═CHR₁ α-olefin, where R₁ is a hydrocarbon radical having 2-10 carbon atoms, are polymerized in each stage, thus obtaining a first copolymer and a second copolymer as above defined.

By way of illustrative example, the process may comprise two stages, where ethylene and propylene are polymerized in a first stage, thus obtaining a second copolymer of propylene with ethylene containing 1-5% by weight of units derived from ethylene, while ethylene, propylene and a CH₂═CHR₁ α-olefin are polymerized in a second stage, thus obtaining a first copolymer containing 80-94% by weight of units derived from propylene, 1-5% by weight of units derived from ethylene and 5-15% by weight of units derived from the CH₂═CHR₁ α-olefin.

The CH₂═CHR₁ α-olefin is generally selected from 1-butene, 1-pentene, 1-hexene, 4-methyl-1-pentene and 1-octene, and is preferably 1-butene.

According to a preferred embodiment of the present invention, the second film layer comprises a composition including a first copolymer of propylene with ethylene and/or one or more CH₂═CHR₁ α-olefins, where RI is a hydrocarbon radical having 2-10 carbon atoms, optionally a second copolymer of propylene with ethylene, preferably containing 1-5% by weight of units derived from ethylene, as well as a linear ethylene copolymer having a density of 0.920 to 0.950 g/cm³. In this manner, the adhesion between the first and the second film layers is further improved.

Preferably, the second film layer comprises a semicrystalline polyolefin composition comprising:

a) 20-60% of a random copolymer of propylene with a C₄-C₁₀ α -olefin containing from 1 to 10% by weight of C₄-C₁₀ α-olefin; and

b) 40-80% of a random copolymer of propylene with a C₄-C₁₀ α-olefin containing from 15 to 40% by weight of C₄-C₁₀ α-olefin.

Advantageously, such composition has a melting point from 135° C. to 150° C., a fraction soluble in xylene at 25° C. lower than 20%, typically lower than 16%, and a heat sealing temperature from 90 to 105° C.

More preferably, the second film layer comprises a semicrystalline polyolefin composition comprising a semicrystalline polyolefin composition comprising three random copolymers of propylene, namely:

a) 25-40%, preferably 28-38%, of a random copolymer of propylene with at least one comonomer selected from C₄-C₁₀ α-olefins, containing from 2 to 10% by weight of recurring units deriving from the comonomer;

b) 25-40%, preferably 26-36%, of a random copolymer of propylene with at least one comonomer selected from C₄-C₁₀ α-olefins, containing from 10 to 20% by weight of recurring units deriving from the comonomer; and

c) 25-40%, preferably 28-38%, of a random copolymer of propylene with at least one comonomer selected from C₄-C₁₀ α-olefins, containing from 6 to 12% of recurring units deriving from the comonomer, wherein the total content of recurring units from the said comonomer, referred to the composition, is equal to or higher than 6% and the respective percentages representing the content of the recurring units in each one of copolymers a), b) and c) are different from each one of the other two, said difference with respect to the percentage of recurring units in each one of the other two copolymers being of at least 1 unit, preferably 1.5 units.

Said preferred composition has, typically, a seal initiation temperature from 110° C. to 120° C., VICAT value, determined according to method ISO 306, generally from 115 to 140° C., values of heat distortion temperature ranging from 65 to 75° C.

According to a further preferred embodiment of the invention, the second film layer comprises a crystalline polyolefin composition comprising:

a) 20-60%, preferably 25-45%, by weight of a random copolymer of propylene with ethylene containing from 1 to 5%, preferably from 2 to 5% by weight, of ethylene; and

b) 40-80%, preferably 55-75%, by weight of a random copolymer of propylene with ethylene and one or more C₄-C₈ α-olefins, the ethylene content being 1 to 5%, preferably 2 to 5%, by weight and the C₄-C₈ α-olefin content being 6% to 15%, preferably 6% to 12%, by weight,

the total content of ethylene in the composition being 1% to 5% and the total content of C₄-C₈ α-olefin in the composition being 2.4% to 12%.

Advantageously, such preferred composition has a melting point from 126 to 147° C., seal initiation temperature from 90 to 114° C., and a fraction soluble in n-hexane at 50° C. lower than 5.5%.

The fraction soluble in n-hexane is determined by suspending in an excess of hexane a 100 micrometer thick film specimen of the composition being analyzed, in an excess of hexane, in an autoclave at 50° C. for 2 hours. Then the hexane is evaporated and the dried residue is weighted.

According to a further preferred embodiment of the invention, the second film layer comprises a crystalline propylene copolymer composition comprising:

a) 20-80% of one or more propylene copolymers selected from the group consisting of (a1) propylene/ethylene copolymers containing 1-7% of ethylene; (a2) copolymers of propylene with one or more C₄-C₈ α-olefins, containing 2-10% of the C₄-C₈ α-olefins; (a3) copolymers of propylene with ethylene and one or more C₄-C₈ α-olefins, containing 0.5-4.5% of ethylene and 2-6% of C₄-C₈ α-olefins, provided that the total content of ethylene and C₄-C₈ α-olefins in (a3) be equal to or lower than 6.5%; and

b) 20-80% of one or more propylene copolymers selected from the group consisting of (b1) copolymers of propylene with one or more C₄-C₈ α-olefins, containing 10-30% of C₄-C₈ α-olefins; (b2) copolymers of propylene with ethylene and one or more C₄-C₈ α-olefins, containing 1-7% of ethylene and 6-15% of C₄-C₈ α-olefins.

This preferred composition advantageously has a low seal initiation temperature, generally lower than 100° C., a low content of a fraction soluble or extractable in organic solvents, generally equal to or lower than 20% by weight in xylene at 25° C. and equal to or lower than 5% by weight in n-hexane at 50° C., and very low haze values, typically lower than 0.5-1%.

Preferably, such preferred composition has melt flow rate MFR(230/2.16) values from 2 to 15 g/10 min while, after subjecting to degradation a precursor composition comprising the same components a) and b) in the above-mentioned proportions, the MFR(230/2.16) of the precursor composition has values from 0.3 to 5 g/10 min, preferably from 0.5 to 3 g/10 min, and the ratio between the MFR(230/2.16) of the final composition to the MFR (230/2.16) of the precursor composition is of from 2 to 20, preferably from 3 to 15.

Thanks to such preferred features, this embodiment envisaging such a composition to form the second film layer advantageously has low seal initiation temperatures, generally lower than 100° C. and a low content of a fraction soluble or extractable in organic solvents, generally equal to or lower than 20% by weight in xylene, as well as very low haze values, typically lower than 0.5-1%.

According to a further preferred embodiment of the invention, the second film layer comprises a composition comprising:

a) 15-60%, preferably from 20-60%, more preferably 20-50%, of a copolymer of propylene with C₄-C₈ α-olefin(s), containing more than 10%, preferably 11% or more, but less than 14%, more preferably up to 13-13.5%, of said C₄-C₈ α-olefins;

(b) 40-85%, preferably from 40-80%, more preferably 50-80%, of a copolymer of propylene with C₄-C₈ α-olefin(s), containing 14-30%, preferably 14.5-25%, more preferably 14.5-22%, of said C₄-C₈ α-olefin(s), and optionally 0.5-3% of ethylene, provided that the total content of C₄-C₈ α-olefin(s) in the propylene polymer composition be higher than 10%.

Advantageously, such composition has low sealing temperatures, generally lower than 100° C., and a low content of a fraction soluble or extractable in organic solvents, generally equal to or lower than 20% by weight in xylene, as well as very low haze values, typically lower than 0.5-1%.

The melting temperature of said preferred composition is generally from 125 to 140° C.

The comonomers of the above-mentioned copolymers may be the same or different and are preferably selected from 1-butene, 1-pentene, 1-hexene, 4-methyl-1-pentene and 1-octene. 1-butene is preferred.

According to a preferred embodiment of the invention, the above-mentioned second film layer further comprises a linear ethylene copolymer, preferably having a density of 0.915 to 0.950 g/cm³, more preferably from 0.920 to 0.950 g/cm³, still more preferably from 0.927 to 0.943 g/cm³ and, more in particular, from 0.930 to 0.940 g/cm³.

Advantageously, the second film layer has an improved adhesion to the first film layer.

According to an alternative embodiment of the invention, both the at least one first film and the at least one third film layer comprise a linear ethylene copolymer having a density comprised between 0.920 and 0.950 g/cm³, but the at least one first film layer comprises a linear ethylene copolymer having a density lower than the density of the at least one third film layer. Alternatively, both the at least one first film and the at least one third film layer comprise a linear ethylene copolymer having a density comprised within the range 0.920-0.950 g/cm³, but the at least one first film layer comprises a linear ethylene copolymer having a density higher than the density of the at least one third film layer. Preferably, the at least one first film layer comprises a linear ethylene copolymer having a density of 0.930 to 0.950 g/cm³, while the at least one third film layer comprises a linear ethylene copolymer having a density comprised between 0.920 and 0.943 g/cm³, more preferably between 0.927 and 0.943 g/cm³, and lower than the density of the linear ethylene copolymer of the at least one first film layer.

According to an alternative embodiment of the invention, the at least one third film layer may comprise a polymer selected from the polymers provided in the first and second film layers, with the proviso that when the third film layer comprises the above-mentioned first propylene copolymer, the linear ethylene copolymer has a density of 0.930 to 0.940 g/cm³. In particular, according to a preferred embodiment, the thermoshrinkable film comprises at least one first film layer comprising a linear ethylene copolymer having a density of 0.930 to 0.940 g/cm³, at least one second film layer comprising a first copolymer of propylene with ethylene and/or one or more CH₂═CHR₁ α-olefins, where RI is a hydrocarbon radical having 2-10 carbon atoms, containing more than 70% by weight of propylene, and at least one third film layer comprising such first copolymer of propylene, wherein said at least one first film layer is arranged between said at least one second film and at least one third film.

When the linear ethylene copolymer has a density within such a range, it is advantageously possible to prepare multilayer films having reduced thickness with respect to those obtainable by using ethylene copolymers having lower density (downgauging), while attaining, at the same time, an effective sealing action at lower temperature with respect to the sealing temperature exhibited by ethylene copolymers having a higher density.

According to a preferred embodiment of the present invention, the first film layer comprises a linear ethylene copolymer having a density of 0.920 to 0.950 g/cm³, and the third film layer comprises a polymer composition including a linear ethylene copolymer having a density of 0.920 to 0.950 g/cm³ as well as a copolymer of propylene with ethylene and/or one or more CH₂═CHR₁ α-olefins, where R₁ is a hydrocarbon radical having 2-10 carbon atoms, containing more than 70% by weight of propylene.

A film having the above-mentioned features a) to c) as defined in attached claim 1 is advantageously processable into any film thickness from 25 to 160 μm and above. Preferably, the film thickness is comprised between 40 and 140 μm, more preferably between 60 and 120 μm.

According to a preferred embodiment of the invention, the thermoshrinkable multilayer film comprises at least one first film layer having a first thickness which is prevailing with respect to (i.e. greater than) both the thickness of the at least one second film layer and the thickness of the at least one third film layer.

In this way, commonly available coextrusion blow film lines which are widely used for a number of film extrusion applications, and which comprise a first central extruder and at least two additional extruders arranged laterally with respect to the first central extruder, may be advantageously used to prepare the multilayer thermoshrinkable film of the invention.

The different layers may be present in variable amounts with respect to the total weight of the film.

Preferably, the thickness of the first film layer constitutes at least 33%, more preferably at least 40% and, still more preferably, at least 50% of the total thickness of the film.

Preferably, the at least one first film layer has a prevailing thickness over each of the second and third film layers, while the thickness of the at least one second film layer is preferably substantially equal to the thickness of the third film layer. More specifically, the second film layer and the third film layer are preferably produced by means of lateral extruders having the same size, smaller when compared to the size of the intermediate extruder used to prepare the first film layer. According to a preferred embodiment, the thickness of the second film layer is preferably set as low as possible, preferably lower than 15 μm, so as to conveniently minimize the production costs. According to an alternative embodiment, the thickness of the at least one second film layer may also differ from the thickness of the third film layer. So, for example, the thickness of the at least one second film layer may be lower than the thickness of the third film layer. In this way, it is conveniently minimized the quantity of propylene copolymer to be used and, in turn, the production costs of the film as said above.

Preferably, the thickness of the second film layer differs from the thickness of the third film layer by not more than 60%, more preferably not more than 50%, still more preferably not more than 40%.

Preferably, the second film layer has a thickness lower than 25%, more preferably 20%, still more preferably 15%, of the total thickness of the multilayer thermoshrinkable film of the invention.

Preferably, the film of the invention comprises three layers as defined above. According to further preferred embodiments of the invention, films comprising more than three layers may be also envisaged. For example, a preferred embodiment of the multilayer thermoshrinkable film of the invention may comprise five layers, and namely, in addition to the above-mentioned first, second and third film layer wherein the first film layer is arranged between the second film layer and the third film layer, two additional layers essentially based on polyethylene which are sandwiched between the first film layer and the second and, respectively, the third film layer. The first film layer has preferably a prevailing thickness over each of the other four film layers.

According to a second aspect thereof, the present invention relates to a process for manufacturing a multilayer thermoshrinkable film as defined above, the process comprising the steps of:
melting the above-mentioned linear ethylene copolymer and the above-mentioned first copolymer of propylene and optionally the above-mentioned second copolymer of propylene;
coextruding the linear ethylene copolymer, the above-mentioned first copolymer of propylene, optionally together with said optional second copolymer of propylene, through an annular shaped die so as to obtain a tubular film comprising the first, second and third layers defined above; and
collapsing said tubular film into said multilayered film.

The thermoshrinkable multilayer film of the invention may be conveniently produced using methods known in the art, such as for example the blow bubble film process by which a tubular film is prepared by extrusion of the polymer components constituting the various layers through a die having an opening of annular shape to give the molten polymer a tube-like shape as it exits the die. The tube of molten polymer is blown up and kept in a tube-like shape by creating a pressure differential between the pressure inside the tube and the pressure outside the tube. One preferred method to create the pressure differential is to use an air supply that blows air into the tube. As air is blown into the tube, the moving tube is stretched and inflated by internal air pressure, which is higher than the atmospheric pressure outside the tube.

The molten tube of polymer material then cools as it moves upward. The cooling process can be expedited by blowing a current of cooling air around the external surface of the tube with an air ring. As the molten polymer material cools, it goes through a phase transition and turns to a solid polymer film. The point where the molten polymer film crystallizes and becomes a solid is defined as the frost line or crystallization line, which therefore delimits the molten material from the solidified material. Beyond the frost line the deformation of the tube is negligible, and the tube consists of one phase material only, the solidified polymer.

Advantageously, as already mentioned, the multilayer thermoshrinkable film of the invention has improved bubble stability, in the sense that the bubble formed during the blowing process has a regular shape in both the radial direction and the axial directions. In other words, the bubble has, on the one side, a frost line which maintains a stable position in the axial direction and, on the other side, a constant diameter. Thanks to these features, the film prepared from the bubble advantageously has a constant thickness.

According to a further aspect thereof, the present invention relates to the use of a multilayer thermoshrinkable film as defined above as a packaging thermoshrinkable film, in particular in the form of a “non-fusion shrink hood”, for enclosing an item or a collection of items. If the item(s) is(are) essentially made of a polyethylene based material, in fact, no sticking or adhesion phenomenon is observed between the film and the item(s).

Furthermore, the present invention relates to the use of a multilayer thermoshrinkable film as defined above as a secondary packaging for enclosing a primary packaging essentially consisting of polyethylene.

### DETAILED DESCRIPTION OF PREFERRED EMBODIMENTS

The present invention is further described by the following examples.

The properties reported in the examples were determined by the following methods. Composition of polymers: percentage by weight of the various monomers were measured with Fourier transform infrared spectroscopy (FTIR) calibrated with ¹³C—NMR.

Xylene-insoluble fraction: 2 g of polymer were dissolved in 250 cm³ of xylene at 135° C., with stirring. After 20 minutes the solution was left to cool, while still stirring, until the temperature reached 25° C. After 30 minutes the precipitated insoluble polymer was separated by filtration. The solvent was removed from the solution by evaporation in a stream of nitrogen and the residue was dried under vacuum at 80° C. to constant weight. In this way the percentage of polymer soluble in xylene at 25° C. was calculated and the percentage of insoluble polymer was thus determined.

The melting temperature was determined according to ISO 3146.

Density was determined according to ISO 1183.

The melt flow rates were measured with a given load at 230° C. for propylene polymers and at 190° C. for ethylene polymers. The melt flow rate (MFR) is the quantity of polymer in grams which the test apparatus standardized to ISO 1133 extrudes within 10 minutes at a temperature of 230° C., respectively 190° C., under a given weight. In particular, the melt flow rates were determined according to the conditions as specified in the following,:

Melt Flow Rate MFR(190/2.16): IS01133:2005(E), condition D.

Melt Flow Rate MFR(190/21.6): IS01133:2005(E), condition G.

Melt Flow Rate MFR(230/2.16): IS01133:2005(E), condition M.

The shrink properties were determined according to ISO 14616.

Table 1 shows the compositions of the polymers, namely an ethylene copolymer indicated by A and a propylene copolymer indicated by B, which were used for producing the films of the Examples as well as the properties thereof.

TABLE 1

| Properties | A | B |
|---|---|---|
| C₂ (% by weight) | 95 | 4 |
| C₃ (% by weight) | — | 90 |
| C₄ (% by weight) | — | 6 |
| C₆ (% by weight) | 5 | — |
| Density g/cm³ | 0.937 | 0.900 |
| MFR(190/2.16) g/10 min | 0.10 | — |
| MFR(190/21.6) g/10 min | 13.0 | — |
| MFR(230/2.16) g/10 min | — | 0.9 |
| Melting temperature ° C. | 124 | 133 |

Production of the Film: General Procedure

Three-layer films were produced by the blow film process, this process comprising the steps of:
feeding each polymer intended to form the layers to a respective extruder,
extruding a three-layer tubular film through an annular shaped die with head temperatures between 200 and 240° C.;
expanding the tubular film;
blowing the tube up and keeping the film in a tube-like shape by creating a pressure differential between the pressure inside the tube and the pressure outside the tube, by means of an air supply that blows air into the tubular film;
blowing a current of cooling air around the external surface of the tubular film with an air ring.

### EXAMPLE 1

A three-layer film was produced as described above on a conventional Macchi blow film pilot plant. Details of the extrusion and blowing operating conditions are given in Table 2.

The three-layer film of Example 1 was made of:
a first film layer consisting of the linear medium density ethylene copolymer A, containing 95% by weight of units derived from ethylene and 5% by weight of units derived from 1-hexene, and having the properties shown in Table 1;
a second film layer consisting of the propylene/1-butene/ethylene terpolymer B, containing 90% by weight of units derived from propylene, 6% by weight of units derived from 1-butene and 4% by weight of units derived from ethylene, and having the properties shown in Table 1. Furthermore, the terpolymer had a maximum melting peak at 137° C. and a crystallinity such that at 90° C. the percentage of material melted was 16.5%, at 100° C. it was 25.5% and at 110° C. it was 36.8%, while the xylene-insoluble fraction thereof was greater than 94.5%;
a third film layer consisting of the above-mentioned ethylene copolymer A.

The first film layer was arranged between the second and third film layers.

A 80 μm thick film was obtained as described above. In percentage terms, the contribution of the first film layer was of 60%, while the contribution of the second film layer was of 15% and the contribution of the third film layer was of 25%.

In Table 2 the extruders are indicated by 3, 1 and 2 depending on the layer formed by each extruder: so, the blow film pilot plant used to manufacture the three-layer film consisted of a first central extruder 1 intended to form the first film layer defined above, and of two additional extruders 2 and 3, arranged laterally with respect to the first central extruder 1, intended to form the second film layer and, respectively, the third film layer as defined above.

The properties of the resulting thermoshrinkable three-layer film are shown in Table 3.

TABLE 2
Example 1

| Extruder | 3 | 1 | 2 |
|---|---|---|---|
| Feed | A | A | B |
| Extruder diameter, mm | 65 | 75 | 65 |
| Extruder temperature | 190-225 | 190-225 | 190-230 |
| profile, ° C. | | | |
| Filter pressure, bar | 453 | 480 | 254 |
| Melt pressure, bar | 327 | 335 | 165 |
| Melt temperature, ° C. | 244 | 227 | 235 |
| Adapter temperature, ° C. | 225 | 225 | 225 |
| Head temperature, ° C. | 230 | | |
| Head diameter, mm | 350 | | |
| Die gap, mm | 1.2 | | |
| Blow-up ratio | 2.7 | | |
| Capacity, kg/h | 25 | 60 | 15 |
| Nominal thickness, μm | 20 | 48 | 12 |

### EXAMPLE 2

A three-layer film was produced by operating as in Example 1. Details of the extrusion and blowing operating conditions were the same as those indicated in Table 2, the only difference being in the feed of extruder 2. More particularly, the three-layer film of Example 2 was made of:
a first film layer consisting of copolymer A;
a second film layer consisting of 80% by weight of copolymer B and 20% by copolymer A; and
a third film layer consisting of copolymer A.

The first film layer was arranged between the second and third film layers.

Operating as described in the general methodology for production of the film according to the blow film process and under the same extrusion conditions as set in Table 2, a 80 μm thick film was obtained in which the contribution of the first film layer was of 60%, while the contribution of the second film layer was of 15% and the contribution of the third film layer was of 25%.

The properties of the resulting thermoshrinkable three-layer film are shown in Table 3.

### EXAMPLE 3

A three-layer film was produced by operating as in Example 1. Details of the extrusion and blowing operating conditions were the same as those indicated in Table 2, the only difference being in the feed of extruders 1 and 2.

More particularly, the three-layer film of Example 3 was made of:
a first film layer consisting of 85% by weight of copolymer A and 15% by weight of copolymer B;
a second film layer consisting of 80% by weight of copolymer B and 20% by weight of copolymer A; and
a third film layer consisting of copolymer A.

The first film layer was arranged between the second and third film layers.

Operating as described in the general methodology for production of the film according to the blow film process and under the same extrusion conditions as set in Table 2, a 80 μm thick film was obtained in which the contribution of the first film layer was of 60%, while the contribution of the second film layer was of 15% and the contribution of the third film layer was of 25%.

The properties of the resulting thermoshrinkable three-layer film are shown in Table 3.

### EXAMPLE 4

A three-layer film was produced by operating as in Example 1. Details of the extrusion and blowing operating conditions were the same as those of Example 3 apart from the blow-up ratio, which was equal to 3.4.

The composition of the three-layer film of Example 4 was the same as that of the three-layer film of Example 3.

The shrinkage properties of the resulting thermoshrinkable three-layer film are shown in Table 3. More particularly, Table 3 shows the properties of the thermoshrinkable three-layer films of Examples 1-4 in both Machine Direction (MD) and Transverse Direction (TD).

The shrinkage properties were tested according to the procedure of standard ISO 14616 in the machine direction (MD) and transverse direction (TD) by setting the films of Examples 1-4 in an oven at a predetermined temperature for a predetermined time. The shrinkage conditions to which the sample were subjected were: heating phase of 20 s, oven with a set temperature of 220° C.

TABLE 3

| | Temperature | | | |
|---|---|---|---|---|
| Example | (° C.) | Fᵣ/mm² (N/mm²) | F_{c}/mm² (N/mm²) | R (%) |
| 1 | MD 154 | 0.13 | 1.72 | 57 |
| | TD 159 | 0.1 | 0.84 | 3 |
| 2 | MD 156 | 0.12 | 1.87 | 56 |
| | TD 161 | 0.13 | 0.87 | 4 |
| 3 | MD 152 | 0.11 | 1.82 | 58 |
| | TD 155 | 0.07 | 1.04 | 6 |
| 4 | MD 146 | 0.07 | 1.90 | 48 |
| | TD 154 | 0.05 | 1.42 | 14 |

The temperatures indicated in Table 3 refer to the temperatures measured at oven closed in the machine (MD) and in the transverse direction (TD).

Fᵣ is the shrinking force, i.e. the force developed by the film when it reaches the temperature corresponding to at which the stress was induced at the time of the manufacture. High film shrinkage is linked to this small force. This small force and this high shrinkage permit the film to gently shrink down on the load. This force is measured during the heating process.

F_{c} is the contracting force, i.e. the force developed by the film during its cooling process. This force, much greater than the shrinkage force, ensures the fastening of the load.

R is the shrinkage ratio, i.e. the decrease in the length of the specimen when it is brought up to the shrinkage temperature, expressed as a percentage of the initial specimen length. It is a measure of the film retraction during the cooling process.

As mentioned above, the films of Examples 1-4 were prepared on a blow film pilot plant. The results shown in Table 3 indicate that a further increase in the contracting force as well as a further improvement in the shrinkage properties of the films in transverse direction is to be expected if the blow-up ratio is set to higher values than those tested in the above-mentioned examples, for example in the order of 4 to 5, as permitted by conventional blow film production plants.

The sealing properties of the thermoshrinkable three-layer films according to Examples 1-4 were also investigated according to the procedure of standard ASTM D 882. The sealing properties were determined by plotting the sealing curve and by determining the broadness of the plateau of such curve: in this way, the maximum sealing strength was determined at different temperatures. A heat sealer RDM HSE-3 was used, in which ten 15 mm width samples, prepared from 42×10 cm film pieces cut in MD, were placed. The seals were tested after 24 h conditioning time at 23° C. and 50% relative humidity. The sealing conditions were the following:
sealing time: 1.2 s
sealing pressure: 6 bar
cell load: 100 N
peel speed: 500mm/min
sealing temperature from 100 to 160° C. every 10° C.

The results are shown in Table 4.

TABLE 4

| Temperature, ° C. | 100 | 110 | 120 | 130 | 140 | 150 | 160 |
|---|---|---|---|---|---|---|---|
| Maximum sealing | 0.14 | 0.63 | 12.54 | 9.79 | 10.39 | 9.47 | 7.30 |
| strength, N - | | | | | | | |
| Example 1 | | | | | | | |
| Maximum sealing | 0.34 | 5.91 | 15.21 | 10.54 | 12.79 | 13.81 | 12.06 |
| strength, N - | | | | | | | |
| Example 2 | | | | | | | |
| Maximum sealing | 0.37 | 5.71 | 19.79 | 14.38 | 14.32 | 17.96 | 14.91 |
| strength, N - | | | | | | | |
| Example 3 | | | | | | | |
| Maximum sealing | 0.35 | 7.13 | 20.27 | 14.02 | 15.53 | 16.89 | 17.53 |
| strength, N - | | | | | | | |
| Example 4 | | | | | | | |

Improved seal strength in the sealing temperature range 120-160° C. was observed.

Analogous sealing tests were carried on corresponding films in which the first film layer and the third film layer were made of conventional LDPE having a density of 0.920 g/cm³ and a MFR(190/2.16) of 0.25 g/10 min, while the second film layer was made of propylene copolymer B described above in the examples according to the invention. Delamination between the first film layer made of LDPE and the second film layer made of propylene copolymer was observed.

The films of the present invention have a number of advantages over the films of the prior art, and in particular over the non-fusion shrink hood films of the prior art. In addition to improved shrinkage and seal properties and the absence of any delamination phenomenon, the films of the invention may be advantageously produced by means of standard film extrusion plants.

1. A multilayer thermoshrinkable film comprising a non-adhesive outer layer comprising a copolymer of propylene with an olefin selected from the group consisting of ethylene, C₄₋₁₂ α-olefins, and mixtures thereof, and two layers of linear polyethylene having a density within the range of 0.920 to 0.950 g/cm³.

2. The film according to claim 1, wherein said linear polyethylene has a density of 0.920 to 0.940 g/cm³.

3. The film according to claim 1, wherein said linear polyethylene has an MFR (190/2.16) lower than 1 g/10 min.

4. The film according to claim 1, wherein said linear polyethylene contains up to 20 mol % of a C₃₋₁₂ α-olefin.

5. The film according to claim 1, wherein the linear polyethylene layer adjacent to the non-adhesive outer layer further comprises a propylene copolymer with an olefin selected from the group consisting of ethylene, C₄₋₁₂ α-olefins, and mixtures thereof.

6. (canceled)

7. The film according to claim 1, wherein the linear polyethylene layer adjacent to the non-adhesive outer layer is thicker than any other layers.

8. (canceled)

9. A packaging hood comprising the multilayer thermoshrinkable film according to claim 1.

10. (canceled)
